(19) United States
(12) Patent Application Publication
(10) Pub. No.: US 2006/0150011 A1
(43) Pub. Date: Jul. 6, 2006

(54) Duplex fault tolerant system and method using DMA

(75) Inventor: Cheol Min Ju, Gyeonggi-Do (KR)

Correspondence Address: FLESHNER & KIM, LLP, P.O. BOX 221200, CHANTILLY, VA, 20153, US

(73) Assignee: LG-Nortel Co., Ltd.

(21) Appl. No.: 11/292,103

(22) Filed: Dec. 2, 2005

(30) Foreign Application Priority Data
Dec. 14, 2004 (KR) 105250/2004

(51) Int. Cl. G06F 11/00

(52) U.S. Cl. 714/14

(57) ABSTRACT

A duplex fault tolerant system and method uses a direct memory access (DMA) scheme to mirror the storage of data in the memories of active and standby circuits. The active circuit includes a monitoring unit to detect a write operation on a system bus, a DMA trigger circuit to generate a trigger signal in response to detection of the write operation, and a FIFO unit to store an address in an active-side memory of where data associated with the write operation is stored. A DMA transfer unit then transfers the data and address to the standby circuit in response to the trigger signal.

### BACKGROUND OF THE INVENTION

1. Field of the Invention

The present invention generally relates to detecting faults in an electronic system.

2. Background of the Related Art

A fault tolerant system is a system which can continue to function without interruption of service when one of its parts fails. Traditionally, this is accomplished by substituting the failed part with a spare part or by performing a preliminary procedure. Fault tolerant systems are commonly used when designing the components of a computer system, control system, or the like. In some instances, fault tolerant systems are only implemented in software. In other instances, they are implemented in hardware, or as a combination of hardware and software. Fault tolerant systems implemented in hardware are usually implemented by duplexing hardware parts.

In a duplex fault tolerant system, data stored in a memory is mirrored. Multiprocessors are then linked to each other in cascade, and the results each produces are compared. When the system fails, the failed part is immediately removed from an operating line (Active Side) and a preliminary operating line (Standby Side) is activated to allow the system to continue functioning.

Direct Memory Access (DMA) is a bus-capable function that allows data to be sent directly from a peripheral device (such as a disk drive) to a memory or specific device on the motherboard of a computer or control system. By using DMA, the CPU (microprocessor) is freed from being involved in the data transfer. This speeds up overall computer operation. Usually, a specified portion of memory is designated as an area to be used for direct memory access.

FIG. 1 is a diagram of a related-art duplex fault tolerant system implemented in a control system. This system includes an active side 1 and a standby side 2. The active side comprises a monitoring unit 3 for monitoring if there is a write operation being performed on the system bus, a FIFO (first in first out) unit 4 for storing the address and data of the write operation, a memory 5 storing the data associated with a write operation, a CPU (central processing unit) 6 for issuing commands and for performing computing operations, and a system controller 7 for controlling operations of the system and transferring the data stored in the memory via a duplex channel (or duplex bus) 15.

The standby side comprises a memory 8, a CPU 9, and a system controller 10, all of which may operate in the same manner as in the active side. In addition, the standby side includes a receiver 11 for receiving data from the active side over the duplex channel. The duplex channel operates as a data transmission path between the active-side and standby-side circuits.

Operation of the duplex fault tolerant system will now be described. The standby side circuit operates as a duplex circuit installed in case active side circuit fails and is unable to operate normally. In order for the fault tolerant system to operate normally in case of a failure in the active side circuit, the same data stored in the memory of the active side is stored in the memory of the standby side. A series of operations must be performed to mirror storage of the data in these memories.

Operations used to mirror the data in the related-art system of FIG. 1 will now be described. The monitoring unit of the active side operates using duplex logic, and monitors a read or write operation generated by the CPU of the active side on the system bus. When a write operation is detected, the content written to the memory, that is, the address and data, are captured from the write operation and stored in the FIFO (first in first out) unit. The system controller of the active side then transfers the stored address and data to the standby side via the duplex channel. When the receiver of the standby side receives the address and data from the active side, the system controller of the standby side analyzes the address and stores the data in a corresponding address of memory 8.

There are several drawbacks associated with the related-art duplex fault tolerant system. For example, the system board that is used is problematic in terms of compatibility, because new duplex logic has to be specially developed for the type of CPU or memory mounted on the active side board. Consequently, when the system CPU or memory is upgraded, a new standby system has to be developed which increases development costs.

Another problem relates to the FIFO unit on the active side. Because the monitoring unit has to capture both address and data from a write operation, the FIFO unit has to store both the captured address and data together. The capacity of the FIFO unit therefore has to be large.

Another problem relates to synchronization. In a general system bus configured in a pipeline manner, the time when an address is transferred to the bus and the time when data is loaded on the bus are not consistent. The address and data must therefore be captured in synchronization. This increases system complexity because the system has to be developed by taking the bus protocol into consideration.

Another problem relates to transmission capacity. Because the captured address and data are transferred via a duplex channel, a larger-than-desired transmission quantity must be maintained at the expense of decreased transfer rates. It is therefore necessary to use high-speed/large-capacity duplex logic capable of increasing the transfer rate.

Another problem relates to efficiency of the active-side CPU. This efficiency is substantially diminished because the active side CPU must necessarily be involved in the transfer of the captured address and data.

Another problem relates to increase hardware requirements. For example, a receiver for receiving address and data transferred from the active side must be provided in the standby side.

In view of the foregoing considerations, it is clear that a need exists for an improved duplex fault tolerant system and method which overcomes all or a portion of the drawbacks of the related-art system enumerated above.

### SUMMARY OF THE INVENTION

An object of the invention is to solve at least the above problems and/or disadvantages and to provide at least the advantages described hereinafter.

Another object of the present invention is to provide a duplex fault tolerant system and method which realizes increased CPU working efficiency and reduced FIFO capacity on the active side of the system.

Another object of the present invention is to provide a duplex fault tolerant system and method with increased system compatibility.

Another object of the present invention is to provide a duplex fault tolerant system and method with a simplified hardware configuration which may be achieved, for example, by removing a receiver from the standby side.

These and other objects and advantages are achieved by providing, in accordance with one embodiment of the present invention, a duplex fault tolerant system comprising: a monitoring unit for monitoring if there is a write operation on the bus of the system and informing a DMA trigger of the result; a FIFO unit for receiving a corresponding address of data written to a memory from the monitoring unit and storing the same; the DMA trigger for triggering the DMA by using the corresponding address of the data stored in the FIFO unit; and the DMA for reading out the data in the address and transferring the data. Preferably, if there is a write operation, the monitoring unit captures the address of the write operation and transfers the same to the FIFO unit.

In accordance with another embodiment, the present invention provides a duplex fault tolerant method comprising: monitoring if there is a write operation on the bus of the system; informing a DMA trigger if there is a write operation; capturing an address from the write operation; storing the captured address in a FIFO unit; generating a DMA trigger signal containing the captured address information; and reading data corresponding to the captured address and mirroring the data via a duplex channel.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram showing a related-art duplex fault tolerant system in a control system;

FIG. 2 is a diagram showing a duplex fault tolerant system in accordance with one embodiment of the present invention;

FIG. 3 is a diagram showing a duplex fault tolerant system implemented in an SMP system in accordance with another embodiment of the present invention;

FIG. 4 is a diagram showing a duplex fault tolerant system in which a monitoring unit and a DMA trigger are configured in slots in accordance with another embodiment of the present invention; and

FIG. 5 is a flow diagram showing steps included in a duplex fault tolerant method in accordance with the one embodiment of the present invention.

### DESCRIPTION OF THE INVENTION AND/OR BEST MODE

The present invention in one or more of its embodiments may be implemented in a duplex fault tolerant system using a direct memory access (DMA) scheme. In other embodiments, the present invention is applied to a control system operating according to other or predetermined standards. In one possible non-limiting application of these systems, the present invention contemplates building a duplex system board using DMA in a control system, where only the address of data written to the memory of the system is monitored and where the data corresponding to the address is mirrored for storage in a standby side using a DMA scheme. This application and other features of the invention are explained in greater detail below.

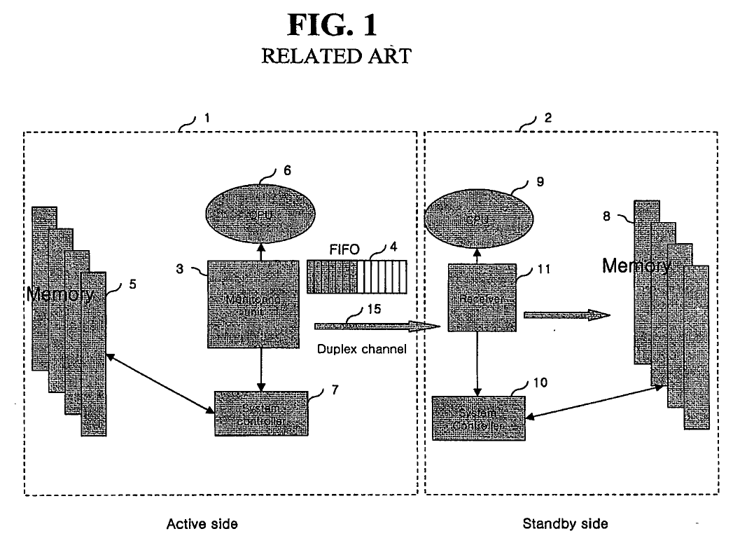

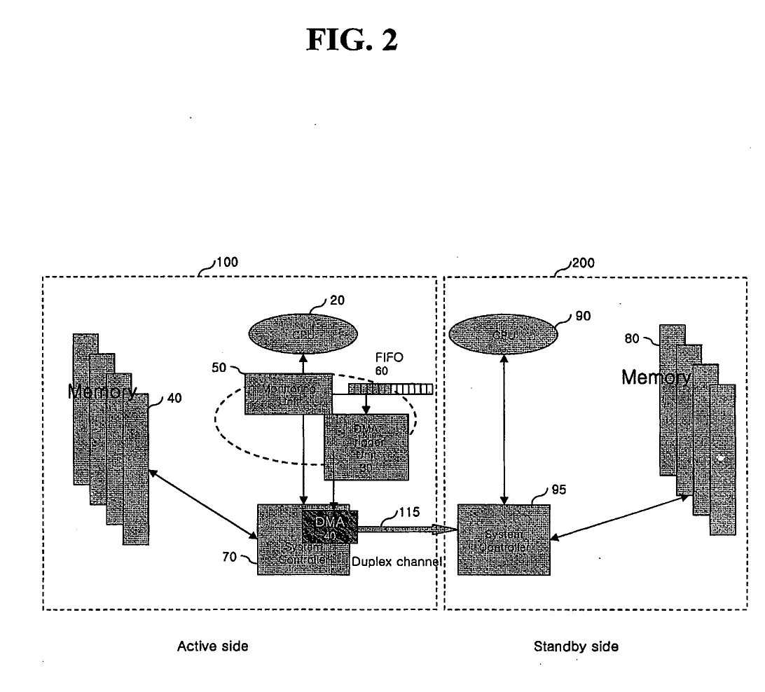

FIG. 2 shows a duplex fault tolerant system in accordance with one embodiment of the present invention. This system includes an active side and a standby side. The active side 100 has a CPU or microprocessor 20, a memory 40, a monitoring unit 50, and a system controller 70. These components may operate in a manner similar to those in FIG. 1 except as noted herein. For example, unlike the related-art system, the system controller may include a DMA unit 90 or the DMA unit may be separately provided. The standby side includes a memory 80, CPU or microprocessor 90, and a system controller 95.

The active side may further include a DMA trigger 30 coupled to DMA unit 40. The standby side 200 preferably has no receiver, which is an essential component in the standby side of the related-art system of FIG. 1. Also, the structure and operation of monitoring unit 50 and FIFO unit 60 of the present invention may be different from those shown in the related-art system.

The monitoring unit 50 detects on the system bus a write operation generated from the active-side CPU, informs the DMA trigger 30 of the write operation, and captures a corresponding address of data associated with the write operation. The data, which is to be written into the active-side memory, is transferred to the FIFO unit 60. The FIFO unit stores the address captured by the monitoring unit, but not the data from such an operation.

The DMA trigger 30 generates a DMA trigger signal containing information of the address stored in the FIFO unit and transfers it to the DMA unit 40. The DMA unit operates, upon receipt of the DMA trigger signal, to extract the address contained in the signal, read data in the corresponding address, and transfer the data to the standby side over the duplex channel 115 where it is stored (mirrored) in the memory 80 of the standby side.

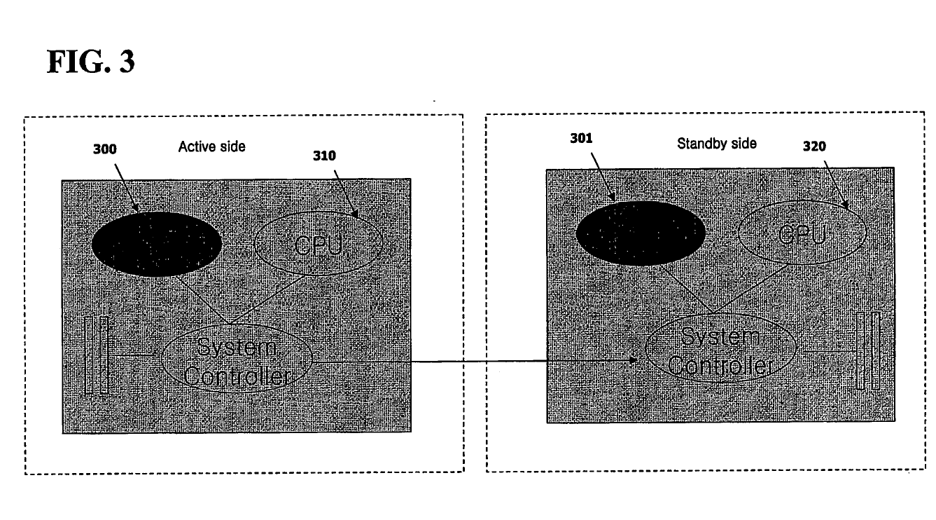

FIG. 3 shows a duplex SMP (symmetric multi-processor) fault tolerant system in accordance with another embodiment of the present invention. In this embodiment, the SMP system is provided with two CPUs 310 and 320, and the fault tolerant system is implemented using DMA by assembling only one of the two CPUs and inserting duplex logic 300 and 301 into the CPU location of the other one. The duplex logic may be a circuit which includes a monitoring unit 50 and a DMA trigger 30 as illustrated in FIG. 2. The operation and functions of these element may also be the same.

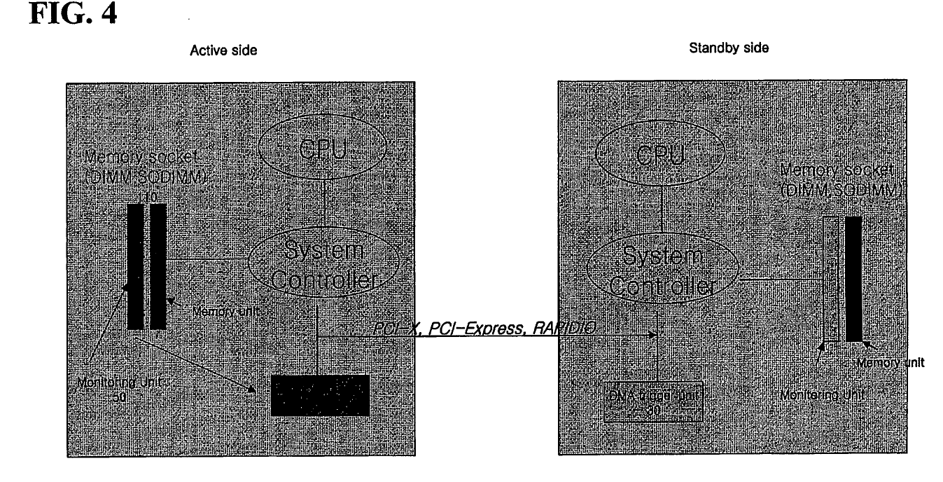

FIG. 4 shows a duplex fault tolerant system, in accordance with another embodiment of the present invention, in which a monitoring unit 50 and a DMA trigger 30 as illustrated in FIG. 2 are configured in slots. More specifically, the slot-type monitoring unit 50 may be mounted in a universal memory slot 110 of a board and the DMA trigger 30 may be mounted in a universal bus slot of a board.

The function and operation of the present invention will now be described in greater detail. Referring to FIG. 2, the monitoring unit 50 detects a write operation or a read operation on a system bus coupled to system controller 70. The write operation may contain data to be written into the memory of the active side, as well as information identifying on the address where the data is to be stored. When the write operation is detected, the memory 40 of the active side may be updated accordingly with the data.

When monitoring unit 50 senses a write operation on the system bus, it also informs DMA trigger 30 of the write operation. The monitoring unit then captures only the address from the detected write operation and transfers it to FIFO unit 60. For example, if the address and data contained in the write operation are 4 bytes and 32 bytes respectively, the monitoring unit captures only the 4-byte address from the write operation and transfers it to FIFO unit 60. The FIFO unit therefore stored on 4 bytes of information in association with the write operation. This is in contrast to the FIFO unit in FIG. 1, which captures both address and data in the write operation. Consequently, the FIFO unit in the related-art system must be larger in terms of capacity (e.g., 36 bytes) compared to the FIFO unit of this embodiment of the present invention which on a comparative basis may have substantially smaller capacity and size.

When the DMA trigger 30 receives a signal indicating detection of a write operation from the monitoring unit, the DMA trigger sends a DMA trigger signal to trigger the DMA unit 40. In the event that DMA unit 40 is embedded in the system controller, the DMA trigger signal may be transferred to the DMA via the system controller. At this time, the DMA trigger signal contains the address stored in FIFO unit 60. The DMA reads data in the corresponding address from the active-side memory using the address information contained in the DMA trigger signal, and transfers it to the standby-side memory 10 over duplex channel 115 preferably in real time. The data is therefore mirrored to the memory of the standby side. Thus, if the circuit of the active side fails, the standby-side circuit is activated to continue operation of the system.

The foregoing functions may be performed either by configuring the monitoring unit 50 and DMA trigger 30 to be integrated in one duplex logic or by configuring them to be moduled in separate slots. For example, as shown in FIG. 4, the system may be mounted on a main circuit board on the active side. Configured in this manner, the monitoring unit 50 and the DMA trigger may be mounted within slots of the board, in addition to other boards or circuits found in or coupled to the board. By integrating the present invention in this manner onto a main circuit board, compatibility is substantially improved.

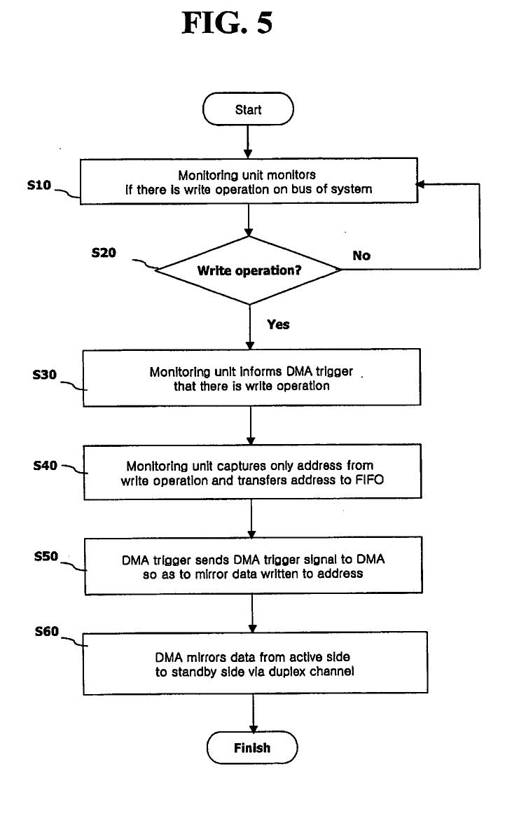

FIG. 5 shows functions performed during the operation of the duplex fault tolerant system in accordance with the one embodiment of the present invention. These functions may correspond to steps included in a duplex fault tolerant method of the present invention. These embodiments may be more clearly understood with reference to FIGS. 2 and 5.

Initially, monitoring unit 50 monitors the bus to determine if a read or write operation has been generated from the CPU of the active side of the system (S10). If a write operation is detected (S20), the monitoring unit informs the DMA trigger 30 of the operation (S30). The monitoring unit then captures only an address from the monitored write operation and transfers it to the FIFO unit 60 (S40).

Next, the DMA trigger 30 generates a DMA trigger signal to trigger the DMA 40 (S50). The DMA trigger signal contains information indicating the address stored in the FIFO unit. If step S50, this information is transferred to DMA 40, and the DMA then mirrors data written to the active side to the standby side via a duplex channel (S60).

The present invention may be suitable for application to an exchanger system, as well as to a system having different bus types. The invention, thus, may be applicable to Gigabit Ethernet or ATM (Asynchronous Transfer Mode) systems.

Thus, in the present invention, the CPU may not be involved in data transfer because data is transferred using the DMA. Therefore, the efficiency of the CPU and system performance can be improved.

Further, the fault tolerant system and method of the present invention can obtain the effect of transferring data updated to the active side in real time, since only the address is captured from a write operation and then update (written) data is transferred using the DMA. Consequently, there is an advantage in that the system and method are free from synchronization problems which occur when related-art systems transfer address and data after capturing both of the address and data from a write operation.

Further, the fault tolerant system and method of the present invention has the advantage of not having to install a receiver at the standby side, since the DMA transfers update data.

Further, the fault tolerant system and method of the present invention provides high compatibility and reliability, and thus has the effect of improving performance of the CPU and memory used in the system, and of reducing costs incurred in the development of a system corresponding to a change of the features.

Further, in the fault tolerant system of the present invention, since only the address is stored in the FIFO unit, the size of the FIFO unit can be substantially reduced. Accordingly, system processing speed can be improved.

Further, in the fault tolerant system of the present invention, because the monitoring unit and DMA trigger are made in separate modules in at least one embodiment and are mounted in slots of the main board of the system, they can be installed in various types of boards. Accordingly, investment costs of system development can be reduced and reliability of performance can be increased.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A duplex fault tolerant system, comprising:
a monitoring circuit which detects a write operation on a bus;
a DMA trigger circuit which receives a detection signal from the monitoring circuit indicative of the write operation; and
a storage circuit which stores information indicative of an address in an active-side memory where data associated with the write operation is stored,
wherein the DMA trigger circuit sends a trigger signal to a DMA unit containing said address information and wherein the DMA unit transfers a copy of the data and the address information to a standby circuit.

2. The system of claim 1, wherein the data associated with the write operation is not stored in the storage circuit.

3. The system of claim 1, wherein the monitoring circuit captures the address information for storage in the storage circuit.

4. The system of claim 1, wherein the monitoring unit is coupled to a slot of a circuit board.

5. The system of claim 1, wherein the storage circuit is a FIFO unit.

6. The system of claim 1, wherein the DMA trigger circuit is coupled to a slot in a circuit board.

7. The system of claim 1, wherein the DMA unit is located within an active-side system controller.

8. The system of claim 1, wherein a system controller of the standby circuit receives the copy of the data and address information, sent from the DMA unit, for storage in a memory of the standby circuit.

9. The system of claim 1, wherein the DMA unit and a system controller of the standby circuit are coupled to a duplex channel.

10. A duplex fault tolerant system, comprising:
an active-side circuit including a memory and a system controller coupled to a bus, wherein the system controller receives information indicative of an address where data is stored in the memory and sends a copy of the data and the address information to a standby-side circuit through a DMA unit.

11. The system of claim 10, wherein the data is derived from a write operation which is detected on a bus.

12. The system of claim 10, wherein the active-side circuit further includes:
a FIFO unit which stores the address information without the data.

13. The system of claim 10, wherein a system controller of the standby-side circuit is coupled to a duplex channel for receiving the copy of the data and address information sent from the system controller.

14. A duplex fault tolerant system, comprising:
a duplex logic circuit to detect a write operation on a bus and to store data associated with the write operation in a first memory;
a FIFO circuit to store an address of the data in the first memory; and
a DMA circuit to transfer a copy of the data stored in the first memory and the address stored in the FIFO circuit to a second memory.

15. The system of claim 14, wherein the first memory is an active-side memory.

16. The system of claim 15, wherein the second memory is a standby-side memory.

17. The system of claim 14, wherein the duplex logic circuit includes:
a monitoring unit to detect the write operation on the bus, inform a DMA trigger circuit of the write operation, capture an address associated with the write operation, and transfer the captured address to the FIFO circuit, wherein the DMA trigger circuit sends a trigger signal to the DMA circuit containing the address of the data stored in the first memory.

18. The system of claim 17, wherein the DMA circuit and the standby-side are coupled to a duplex channel.

19. The system of claim 17, wherein the duplex logic circuit is installed in one of two CPUs in an SMP system.

20. The system of claim 14, wherein the DMA circuit transfer the copy of the data and the address in response to receipt of a trigger signal from a DMA trigger circuit.

21. The system of claim 20, wherein the trigger signal contains information on the address captured by the monitoring unit.

22. The system of claim 14, wherein the DMA circuit mirrors the data written to the first memory to the second memory via a duplex channel.

23. A duplex fault tolerant method, comprising:
capturing an address from a write operation detected on a bus;
storing said address in a buffer;
generating a trigger signal containing said address; and
sending said address stored in the buffer and data stored in an active-side memory at said address to a standby circuit in response to the trigger signal, said data and address sent to the standby circuit through a DMA unit.

24. The method of claim 23, wherein said data and address are sent to the standby circuit through a duplex channel.

25. The method of claim 23, wherein the trigger signal triggers a DMA unit to send said address and data.

26. The method of claim 23, wherein a system controller of the standby circuit receives said address and data from a duplex channel.
